(19) United States
(12) Patent Application Publication
(10) Pub. No.: US 2004/0201120 A1
(43) Pub. Date: Oct. 14, 2004

(54) Gypsum wallboard process

(75) Inventor: Elizabeth Colbert, Newark, DE (US)

Correspondence Address: BURNS DOANE SWECKER & MATHIS L L P, POST OFFICE BOX 1404, ALEXANDRIA, VA, 22313-1404, US

(73) Assignee: LAFARGE NORTH AMERICA, INC.

(21) Appl. No.: 10/768,096

(22) Filed: Feb. 2, 2004

Related U.S. Application Data
(60) Provisional application No. 60/443,852, filed on Jan. 31, 2003.

(51) Int. Cl. B29C 44/20; B05D 1/02; B29C 44/58

(52) U.S. Cl. 264/45.8; 264/50; 366/101; 427/180

(57) ABSTRACT

A method of manufacturing gypsum board includes applying compressed air to an input end of a tube, wherein the tube includes the input end, an output end, and a venturi located between the input end and the output end; admitting a foaming agent to the input end of the tube so as to form a mixture of the compressed air and the diluted foaming agent; passing the mixture through the venturi and out the output end; combining the mixture with gypsum and water to form a gypsum slurry; and casting the gypsum slurry onto a continuous web for forming a gypsum board.

### CROSS-REFERENCE TO RELATED APPLICATIONS

The present application claims the benefit of U.S. Provisional Application No. 60/443,852, filed in the United States on Jan. 31, 2003, the entire contents of which are hereby incorporated herein by reference.

### BACKGROUND OF THE INVENTION

1. Field of the Invention

The present invention relates to a method and device for forming gypsum board, and in particular to a method and device for forming lightweight gypsum board.

2. Description of Related Art

In one type of conventional gypsum board manufacturing system, a mixer such as a pin mixer, is provided for mixing a dry powdered gypsum with water and other additives such as fibrous materials, starch, foam, retarders, accelerators, and/or water-resistance additives. The foam is added to decrease the density of the resulting product.

In one conventional system, the foam is generated with a static foam generator. The static foam generator includes a tube having a plurality of chambers or stages, each of which is filled with a particulate medium, such as pieces of broken glass or other sharp particulates. The purpose of the particulate medium is to create bubbles in a liquid passing through the static foam generator. Such static foam generators are sometimes referred to as a stacked tube foam generators. In such stacked tube foam generators, the particulate matter is preferably arranged so that the particles are decreasing in size from the beginning of the tube to the discharge end of the tube.

In a typical stacked tube foam generator, a foam concentrate such as a surfactant and water are added to the input end of the tube. The mixture of foam concentrate and water is then pushed through the tube with pressure in order to create foam bubbles as the mixture passes through the tube.

The conventional stacked tube foam generators have at least two disadvantages. One, in order to effectively generate proper sized foam, a plurality of chambers is required. Accordingly, it takes a long time and a certain amount of pressure to pass the foaming medium through the stacked tube generator. Second, in view of the fact that, especially at the latter stages, the spaces between the particulate matter are relatively small, the liquid foaming medium tends to congeal on the particulate matter and clog the tube after a certain amount of use.

Accordingly, the stacked tube foam generators require a relatively high amount of maintenance.

U.S. Pat. No. 6,422,734 discloses another type of static foam generating apparatus.

Still another type of foam generator used in a conventional gypsum board manufacturing apparatus includes two Deming pumps arranged in series. The upstream pump is typically the more powerful of the two pumps, and the downstream pump is arranged in a reversed direction, so that the first or upstream pump forces the foaming medium through the downstream pump in the reverse direction. This system of combined Deming pumps is relatively bulky and takes a certain amount of floor space and power to operate. In addition, the Deming pumps are expensive to make, and require a high level of maintenance, in that they are intricate apparatus involving many moving parts.

In one embodiment using the Deming pumps, the foaming medium comprises water and about 0.15% surfactant and an air pressure of about 103 psi. The foam generated has a density of about 6 to 10 lbs/ft³. The flow rate of the surfactant is about 0.1 to 0.3 pounds per minute, and the flow rate of the water is about 100 to 200 pounds per minute.

Unrelated to the gypsum manufacturing board industry, jet pumps, also known as adductors, ejectors, injectors, and venturi pumps, have been used in other industries for mixing liquids, and, in some cases, creating foam. A jet pump includes a primary inlet at an input end which is in axial alignment with the primary axis of the pump. A secondary or suction inlet is provided, typically oriented at an angle with respect to the primary inlet, also at the input end of the pump. See FIG. 3. In one industry, i.e., the firefighting industry, a high pressure source of compressed air is applied to the primary inlet, and a source of foam medium, such as surfactant and water, is applied to the secondary inlet. As the compressed air passes rapidly through the main body of the pump, a venturi or suction effect draws in the foam medium through the secondary inlet. As the foam medium is mixed with the high pressure air stream, foam is created and is ejected through a discharge outlet of the jet pump.

Such foam creating jet pumps are sold by McMaster-Carr for use in the firefighting industry.

### OBJECTS AND SUMMARY

It is an object of the present invention to provide a method and device for manufacturing lightweight gypsum boards, wherein the method and device provide an efficient and effective mechanism for creating foam to be added to a gypsum slurry in the manufacturing process.

### BRIEF DESCRIPTION OF THE DRAWINGS

FIG. 1 is a schematic view of a preferred embodiment of the present invention.

FIG. 2 is a schematic view of a gypsum board manufacturing system.

FIG. 3 is a cross-sectional view of a conventional foam generating gun.

### DETAILED DESCRIPTION OF THE PREFERRED EMBODIMENTS

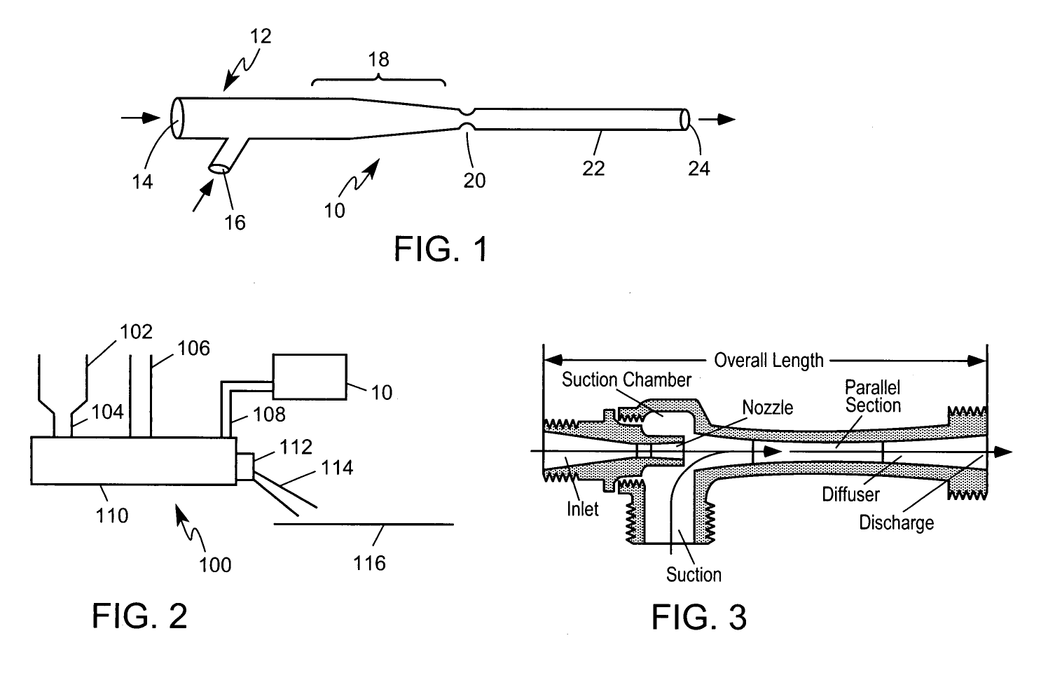

A foam generator according to a preferred embodiment of the present invention is illustrated in FIG. 1. At the input end 12 of the foam generator 10, a first inlet 14 is arranged, preferably in axial alignment with a principle axis of the foam generator. A source (not shown) of compressed air is attached to the first inlet 14 for injecting compressed air into the input end 12 of the foam generator 10.

Also at the input end 12 of the foam generator 10 is a secondary or suction inlet 16. The secondary inlet 16 may be arranged obliquely with respect to a principle axis of the foam generator 10, as illustrated in FIG. 1, or the secondary inlet 16 may be arranged substantially perpendicularly to the principle axis of the foam generator 10.

The secondary inlet 16 is connected to a source or supply of foaming medium. The foaming medium can be any one of a number of materials used for generating foam. In a preferred embodiment, the foaming medium includes a mixture of surfactant and water. In the preferred embodiment, the surfactant is sold by the Thatcher Company of Salt Lake City, Utah under the name SURFACTANT TF®. In the preferred embodiment, the foaming medium includes a ratio of about 0.15% surfactant to water. However, other surfactants, and other ratios, can be used in accordance with the principles of the present invention. SURFACTANT TF® is a nonproteinaceous surfactant.

As the compressed air passes through the inlet end 12, a suction is created, which draws the foaming medium in through the secondary inlet 16. The air and foaming medium are mixed in a suction chamber in the inlet end 12 of the foam generator 10.

The combined mixture of air and foaming medium pass through a tapered intermediate portion 18 of the foam generator 10. In a preferred embodiment of the foam generator 10, the tapered intermediate portion 18 is about six to twelve inches in length, and over this length the diameter is reduced gradually from about 1½ inches at the upstream end to about 1 inch at the downstream end in a gradually tapered manner.

Downstream of the intermediate portion 18 is a venturi portion 20, which includes a restriction in the passageway.

Downstream of the venturi portion 20 is a discharge section 22 which, in a preferred embodiment, includes a substantially uniform diameter that is greater than the restriction of the venturi.

The combined air and foaming medium is discharged from the foam generator 10 through the outlet 24 in the form of a lightweight foam.

The density of the foam discharged from the outlet 24 is dependent upon a number of factors, including the foaming medium used and the air pressure applied at the first inlet 14. However, in one embodiment, when the foaming medium comprises water and about 0.15% surfactant and an air pressure of about 103 psi, the foam generated with the foam generator 10 has a density of about 3 to 6 lb/ft³, and in particular about 4.5 lb/ft³. The flow rate of the air is about 65 cubic feet per minute, the flow rate of the surfactant is about 0.1 to 0.2 pounds per minute, and the flow rate of the water is about 50 to 100 pounds per minute.

In another embodiment, the foam generated with the same foaming medium has a density of about 3 lb/ft³. By varying the air pressure and the concentration of the surfactant in the water, foam densities can be achieved between about 3 lb/ft³ up to or greater than 11.5 lb/ft³.

In view of the fact that the foam generated by the foam generator 10 has a density that is lower than that conventionally generated with the Deming pumps, less water is introduced to the system in the foaming medium, than in a conventional process. In order to ensure that sufficient water is added to the system for complete hydration of the gypsum, it may be necessary to add additional water to the pin mixer.

As a result of the density of the foam, in some embodiments, the total water added may be such that the amount of water needed to be dried from the board in the dryer is reduced compared to conventional foams. For example, the present invention can reduce the amount of water needed to make a lower density foam by about 50%. Specifically, if the aforementioned Deming pump system requires 200 pounds of water per minute for a particular application, the disclosed embodiment of the present invention would use only about 100 pounds of water per minute for the same application, resulting in a reduction of about 100 pounds of water per minute.

As a result of this reduction in water, the temperature of the dryer can be reduced by about 80 degrees F., or the line speed can be increased about 10 feet per minute, or some combination of the two.

According to an embodiment of the present invention, foam generated as described above and as illustrated in FIG. 1 is used in the manufacture of gypsum board. One such system is schematically illustrated in FIG. 2. In FIG. 2, the gypsum board manufacturing system 100 includes a primary mixer 110, which can be a pin mixer or some other mixing system. Gypsum powder is delivered to the primary mixer 110 from a source 102 through a conduit 104. In addition, water is added through a conduit 106. Numerous other additives, not illustrated herein, but well known to those of ordinary skill in the art, may also be added to the primary mixer. Such additives may include fibrous materials, starch, foam, retarders, accelerators, and/or water-resistance additives.

The discharged foam is directed to the gypsum board manufacturing system 100 through a conduit 108. See FIG. 2. The foam may be added directly to the primary mixer 110, as illustrated schematically in FIG. 2, or the foam may be injected into the system at some other location, such as between the primary mixer 110 and a cannister 112, directly into the cannister 112, into some other mixing apparatus (not shown) downstream of the primary mixer 110, or into a passage 114 downstream of the primary mixer 110. The slurry is then deposited from the passage 114 onto a facing sheet on a conveyor 116.

The illustrated arrangement of the conduits 104, 106, 108 is schematic, and is not intended to illustrate the actual location of the conduits with respect to the system 100.

The principles, preferred embodiments and manner of use of the present invention have been described in the foregoing specification. However, the invention which is intended to be protected is not to be construed as limited to the particular embodiments described. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the invention be embraced thereby.

What is claimed is:

1. A method of manufacturing gypsum board, comprising:
applying compressed air to an input end of a tube, wherein the tube includes the input end, an output end, and a venturi located between the input end and the output end;
admitting foaming agent to the input end of the tube so as to form a mixture of the compressed air and the foaming agent;
passing the mixture through the venturi and out the output end;
combining the mixture with gypsum and water to form a gypsum slurry; and
casting the gypsum slurry onto a continuous web for forming a gypsum board.

2. The method of claim 1, wherein a diameter of the tube decreases between the input end and a region in the tube upstream of the venturi.

3. The method of claim 2, wherein the diameter decreases gradually over a distance of greater than or equal to about six inches.

4. A method of manufacturing gypsum board, comprising:
applying compressed air to an input end of a tube, wherein the tube includes the input end, an output end, and a tapered region between the input end and the output end, wherein a diameter of the tube decreases in the downstream direction in the tapered region;
admitting a foaming agent to the input end of the tube so as to form a mixture of the compressed air and the foaming agent;
passing the mixture through the tapered region and out the output end;
combining the mixture with gypsum and water to form a gypsum slurry; and
casting the gypsum slurry onto a continuous web for forming a gypsum board.

5. The method of claim 4, further comprising a venturi in the tube between the tapered region and the output end.

6. The method of claim 1, further comprising the step of adjusting a size of bubbles in the mixture output from the tube by adjusting a pressure of the air applied to the tube.

7. The method of claim 1, wherein the foaming agent is a nonprotenaceous surfactant.

8. The method of claim 1, wherein the interior of the tube is substantially smooth between the input end and the output end.

9. An apparatus for manufacturing gypsum board, comprising:
a foam generator including a tube having an input end, an output end, and a venturi located between the input end and the output end;
a mixer for mixing gypsum powder and water into a gypsum slurry;
a passage for delivering the gypsum slurry to a facing sheet on a conveyor; and
a conduit for delivering foam from the foam generator to either the mixer or a portion of the apparatus between the mixer and the conveyor.

10. The apparatus of claim 9, wherein a diameter of the tube decreases in a region in the tube upstream of the venturi.

11. The apparatus of claim 10, wherein the diameter decreases gradually over a distance of greater than or equal to about six inches.

12. An apparatus for manufacturing gypsum board, comprising:
a foam generator including a tube having an input end, an output end, and a tapered region located between the input end and the output end;
a mixer for mixing gypsum powder and water into a gypsum slurry;
a passage for delivering the gypsum slurry to a facing sheet on a conveyor;
a conduit for delivering foam from the foam generator to either the mixer or a portion of the apparatus between the mixer and the conveyor.

13. The apparatus of claim 9, wherein the interior of the tube is substantially smooth between the input end and the output end.
